(19) United States
(12) Patent Application Publication
(10) Pub. No.: US 2001/0032972 A1
(43) Pub. Date: Oct. 25, 2001

(54) Lifting device

(76) Inventor: John P. Fillisetti, Staten Island, NY (US)

Correspondence Address: SALVATORE C. MITRI, 263 Bryant Avenue, Staten Island, NY, 10306, US

(21) Appl. No.: 09/828,515

(22) Filed: Apr. 9, 2001

Related U.S. Application Data
(60) Provisional application No. 60/197,596, filed on Apr. 18, 2000.

(51) Int. Cl. B66D 1/36

(52) U.S. Cl. 254/334

(57) ABSTRACT

There is disclosed a lifting device for lifting and moving heavy and/or cumbersome objects such as tree stumps, large rocks, logs, landscaping rail road ties, manhole covers, and the like. The device has a central housing and a plurality of support legs pivotally secured adjacent their upper ends to the housing. The lower ends of the support legs are mounted on wheels equipped with brakes to facilitate moving and stabilizing the device. A winch is mounted to one of the support legs and a pulley is suspended from the housing. One end of a first flexible means is wound about the winch, its other end is provided with a lock means and its intermediate length is threaded over the pulley. One end of each of a plurality of second flexible means is secured to the lock means while the other end of each is provided with means to engage a heavy and/or cumbersome object.

### RELATED APPLICATIONS

This application is a continuation-in-part of of co-pending Provisional Application No. 60/197,596 filed Apr. 18, 2000.

### FIELD OF THE INVENTION

This invention is directed to a device for lifting heavy objects such as large rocks, tree stumps, logs, landscaping rail road ties, manhole covers, and the like. More particularly, the lifting device of this invention is capable of being positioned over an object to be lifted and, once the object has been lifted, moving the lifted object to another location. Even more particularly, the lifting device of this invention can be readily and easily operated by a single individual.

### BACKGROUND OF THE INVENTION

The lifting and moving of heavy objects such as large rocks, tree stumps and logs when clearing land or moving landscaping rail road ties into position or removing manhole covers are typically accomplished by at least two workers using crowbars, levers, cumbersome and costly mini cranes, and the like. Many times, such lifting and moving efforts are accomplished solely by the muscular efforts and labors of the workers.

For example, manhole covers are generally removed by two workers using crowbars to unseat the manhole cover and then manually move the manhole cover away from the access port. With the increasing tendency to place power lines and communication conduits underground and provide an ever growing suburbia with sufficient sewer and storm drainage systems, the number of underground access ports needed to service these systems has also increased thereby increasing the number of manhole covers needed to close and protect these access ports.

A variety of mechanisms and devices have been proposed to simplify and ease the burden of lifting heavy and cumbersome objects such as manhole covers. For example, U.S. Pat. No. 4,181,290 to Affolter discloses a device to remove manhole covers having a vertically rotatable rod and a horizontally disposed lever arm mounted upon a support base. The inner end of the lever arm is pivotally secured to the support base and the other end of the lever arm is provided with means to engage a manhole cover. A cable secured adjacent the lower end of the vertical rod interconnects the vertical rod with the lever arm intermediate its ends. After a manhole cover has been secured to the horizontal lever arm, the vertical rod is rotated about its longitudinal axis to pivot the horizontal arm upwardly through the connecting cable and thereby lift the manhole cover. The vertical rod can be rotated by means of a hydraulic jack, a hydraulic or pneumatic cylinder, a hand operated cable reel, or a gear actuated stem.

U.S. Pat. No. 4,365,786 to Osteen discloses a device for moving, positioning and holding a construction work piece such as a pipe or a beam or a similar object suspended above a work area. The device includes a vertically disposed tubular support base having angularly disposed and spaced apart support legs and a tubular extension telescoped within a horizontal, tubular support means. Means are provided to adjust the height of the tubular extension within the tubular support means. The upper end of the tubular extension is secured to a horizontally disposed operating lever arm that can be horizontally rotated about the upper end of the tubular extension. One end of the lever arm is provided with means to engage and hold a construction work piece. An adjustable anchor means is connected to the other end of the lever arm and the support base to maintain the lever arm in position without operator attendance.

U.S. Pat. No. 4,365,925 to Girtz discloses a manhole cover lifting device having an elongated lever arm equipped with manhole cover engaging means at one end and mounted to a strut support means adjacent its other end. The strut support means serves as a fixed fulcrum for the lever arm and is mounted on wheels so that the lever arm can be rolled into position over a manhole cover. After being connected to a manhole cover, the lever arm must be manually depressed in order to lift the manhole cover free of the access port and manually be maintained in its depressed condition while moving the manhole cover away from the access port.

U.S. Pat. No. 4,660,679 to Ostrobrod discloses a tripod assemblage that is capable of being positioned over an access port or other underground work area. The assemblage is equipped with a signaling means to alert workers above ground when a worker underground and out of sight has been disabled or injured and cannot return to the surface. The assemblage includes a harness having a cable that communicates with the signaling means with the free end of the cable secured to a hand operated winch. The underground worker dons the harness so that should the worker become disabled or injured, the worker can activate the signal through the cable and be manually winched to safety by the above ground workers.

U.S. Pat. No. 5,165,661 to Wright discloses a manhole cover removing device having a lever arm pivotally and rotatably mounted at one end to a triangularly shaped planar top which, in turn, is mounted to a base member supported on legs. The device includes link chains secured to the lever arm intermediate its ends for engaging a manhole cover. To operate the device, the free, unsecured end of the lever arm is manually lifted to raise the manhole cover and then manually rotated away from the access port opening. To replace the manhole cover, the free end of the lever arm is again manually lifted and rotated over the open access port and then manually lowered to cover the access port.

While the devices disclosed in the foregoing patents are of interest, they do not provide means for engaging and lifting a variety of heavy objects, including manhole covers. In addition, many of these devices are of complex and unwieldy construction, are costly to manufacture, are cumbersome to operate or do not substantially reduce the muscular effort and labor required.

### SUMMARY OF THE INVENTION

It has now been found that the shortcomings noted above are overcome by the lifting device of this invention. The lifting device of the invention is of simple construction, economical to manufacture, can be used to lift a variety of heavy and cumbersome objects and can be readily and easily operated by a single operator or workman. In general, the lifting device of the invention comprises: a central, cylindrical housing member having a closed upper end and an open bottom; a plurality of vertically disposed, spaced apart U-shaped flange members secured about the outer circumference of said central housing; a plurality of support legs pivotally secured at their upper ends to said flange members; a vertically disposed support means secured at its upper end to said closed upper end so that the lower end of said support means extends beyond the lower end of said open bottom; a pulley secured to the lower end of said support means; a winch means mounted to one of said support legs; a first flexible means, one end of which is wound about said winch means, the intermediate length of which is threaded over said pulley and the other end of which is secured to a locking means; and, a second, flexible means, one end of which is secured to said locking means and the other end of which has means to engage and lift heavy objects.

In one embodiment, the support legs are provided in two sections, an upper section and a lower section, with the lower section telescoped within the upper section and having means to lock the two sections together. With this arrangement, the height of the lifting device over the object to be lifted can be adjusted as desired or required.

In another embodiment, the free ends of the support legs are mounted on wheels equipped with a brake mechanism so that the lifting device can be rolled into position over the object to be lifted, the wheels can be locked to stabilize and secure the lifting device in place as the object is lifted and then the wheels can be unlocked so that the lifting device carrying the lifted object can be rolled out of the way or to a desired location.

In a further embodiment, the second flexible means comprises a plurality of second flexible members of equal length.

In still another embodiment, the second flexible means comprises a plurality of second flexible members of varying lengths.

In still a further embodiment, the engaging means comprises one or more hook members.

A variety of materials can be employed for both the first and the second flexible means such as lengths of flexible chain, natural or synthetic rope, wire rope, wire cable, and the like. Reference throughout this application and in the appended claims to the first and second flexible means should be understood as including and is intended to include, without limitation, all such materials and their equivalents. Preferably, both the first and second flexible means employed are commercially available wire cables encased in a sheath of tough, durable and flexible plastic.

### BRIEF DESCRIPTION OF THE DRAWING

A preferred embodiment of the lifting device of the invention is illustrated in the accompanying drawing wherein:

FIG. 1 is a perspective view of the lifting device of the invention;

FIG. 2 is an enlarged view taken in the direction of line 2-2 of FIG. 1 illustrating details of the central housing with the support legs in a collapsed condition;

FIG. 3 is an enlarged view taken in the direction of line 3-3 of FIG. 2 illustrating details of the attachment means at the upper ends of the support legs; and,

FIG. 4 is an enlarged sectional view taken on the line 4-4 of FIG. 1 illustrating a preferred embodiment of the support legs.

### DETAILED DESCRIPTION OF THE DRAWING AND THE INVENTION

Details of the lifting device of the invention and various preferred embodiments thereof will become more apparent from the ensuing description when considered together with the accompanying drawing wherein like reference numerals denote like parts.

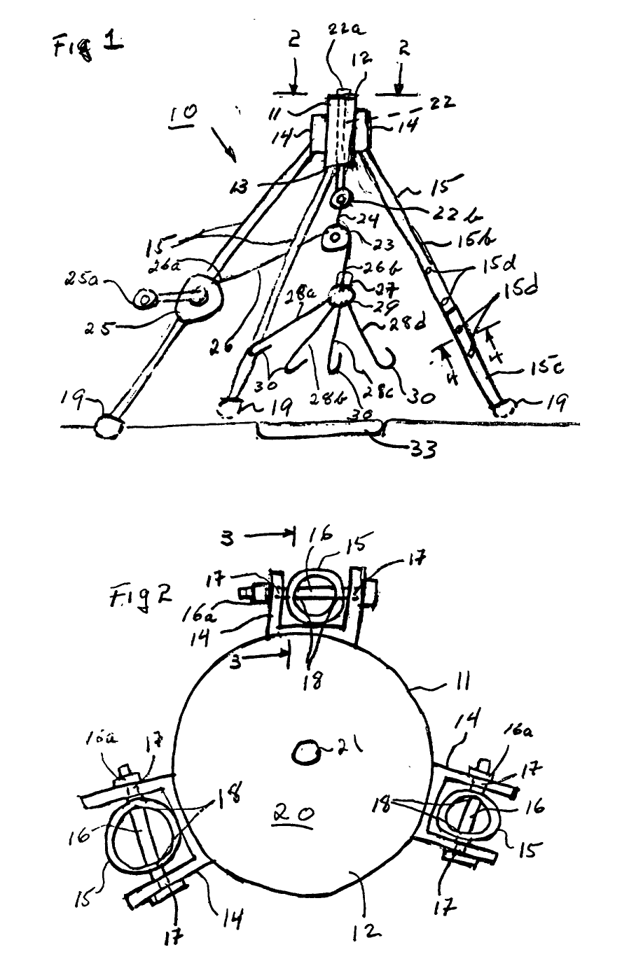

As can be seen in FIGS. 1-3, the lifting device of the invention, generally identified by reference numeral 10, comprises a central housing 11, preferably in the form of a tubular cylinder, having a closed top 12 and an open bottom 13. Secured to the outer wall of the central housing and secured thereto by conventional means are a plurality of equi-spaced, outwardly extending, vertically disposed U-shaped flange members 14. In the embodiment illustrated in FIGS. 1 and 2, three U-shaped flange members are used and are spaced at about 120 degrees from one another about the outer wall of central housing.

A plurality of support legs 15 (preferably three) which can be of any geometrical configuration such as circular or round, oval, square, rectangular, or the like, are pivotally secured adjacent their upper ends 15a within the flange members 14 by means of bolts 16 threaded through apertures 17 in the sides of the flanges and through apertures 18 adjacent the upper ends 15a of the support legs and secured by means of lock nuts 16a as shown in FIGS. 2 and 3. When support legs 15 are pivoted outwardly from their collapsed, vertical condition, shown by short dash lines in FIG. 3, their upper ends 15a contact the inner flange wall 14a (FIG. 3) so that the lower ends of the support legs can be placed on a surface. In this condition, the support legs are firmly and securely locked in place After the lifting and moving chore has been completed, the support legs are pivoted to their vertical, collapsed condition and the lifting device stored for future use.

To facilitate positioning the lifting device over an object to be lifted and then carrying and moving the lifted object to a desired location, the lower ends of support legs 15 are mounted on wheels 19 (FIG. 1) of the type that are equipped with a brake mechanism. This enables the lifting device to be rolled into position over an object whereupon the wheels can be locked by the brake mechanism to stabilize and firmly secure the device in place while the object is being lifted. After the object has been engaged and lifted as described in more detail hereinafter, the brake mechanism can be disengaged and the device carrying the lifted object can be rolled to another location.

As shown in FIGS. 2 and 3, the upper end of central housing is closed with a cap or cover 20 having a centrally located aperture 21 formed therein through which an eye bolt 22 is secured by means of, for example, a self locking nut 22a so that the eye end 22b of the eye bolt 22 extends vertically downward within the central housing with the eye end 22b protruding beyond the open lower end 13 of the central housing 11 (FIG. 1).

A pulley or sheave 23 is secured to the eye end 22b of eye bolt 22 by conventional means such as a short length (three or four links) of galvanized chain or steel rings 24 so that the pulley or sheave 23 is positioned below and spaced from the eye end 22b of the eye bolt 22 as illustrated in FIG. 1.

A commercially available winch means 25 such as a boat winch of the type that includes a winch handle 25a and having a lock ratcheting mechanism and that is typically used to winch boats onto carrying trailers is secured to one of the support legs intermediate its ends as shown in FIG. 1. The winch means 25 is preferably permanently affixed to the support leg using conventional nuts and bolts

The body of a first flexible means 26 consisting of a plastic encased wire cable is threaded over the pulley or sheave 23 and one end 26a of the wire cable is wound about the drum of the winch means 25. To the other end 26b of the wire cable there is affixed a snap lock 27 such as a carabiner to receive an object engaging means.

As shown in FIG. 1, the object engaging means in this embodiment comprises a second flexible means consisting of a plurality of individual lengths of plastic encased wire cable 28a, 28b, 28c and 28d. One end of each of the second wire cable flexible means 28a-28d is secured to a galvanized or steel ring member 29 by conventional means such as dog clamps (not shown). The length of the second wire cable flexible means should be sufficient to enable their free ends to firmly engage the object desired to be lifted and moved. For example, when the objects to be moved are relatively long logs, landscaping rail road ties, and the like, the length of the second wire cable flexible means should be from about 2′ to about 4′ and their free ends should be equipped with suitable clamps or hooks to firmly engage, hold and carry the logs, rail road ties, or similar objects. When the objects to be moved are bulky and/or cumbersome such as large rocks, tree stumps, and the like, the length of the second wire cable flexible means should be from about 18″ to about 2′ and be similarly equipped with suitable clamps or hooks to firmly engage, hold and carry the object to be lifted and moved. If desired or as required, the lengths of the second wire cable flexible means can be mixed or varied to accommodate irregularly shaped and cumbersome objects such as large tree stumps.

In the embodiment illustrated in FIG. 1, the lengths of each of the second wire cable flexible means 28a-28d is about 18″ and their free ends are secured to hook members 30 by conventional means such as dog clamps as this embodiment is intended to lift and move manhole covers.

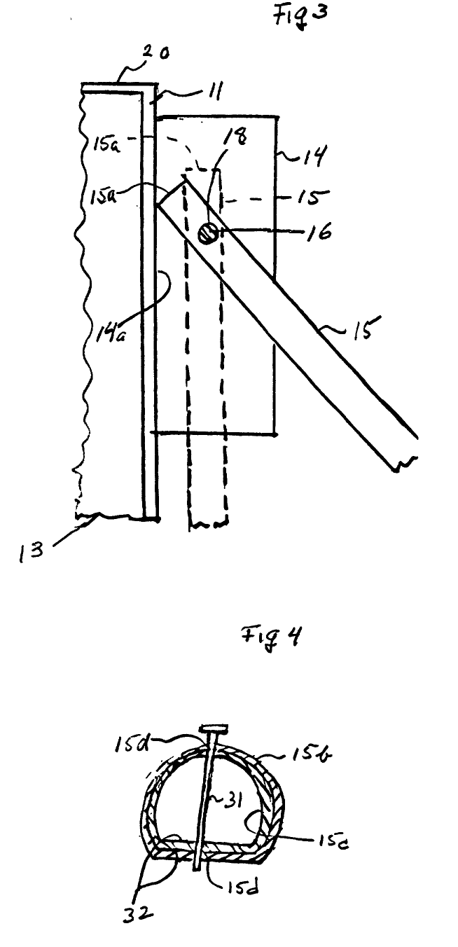

The support legs 15 of the lifting device of the invention are preferably provided in two sections, an upper section 15b and a lower section 15c (FIG. 1) with the lower section 15c telescopically seated within the upper section 15b in a close fitting relationship as best seen in FIG. 4. This enables the lower section 15c to be extended outwardly from the upper section 15b a desired length so that the lifting device can be positioned at an appropriate height above the object to be lifted and moved. In order to secure the two sections together when the lower section 15c is extended, each section is provided with a plurality of apertures 15d along their lengths so that when a set of apertures in the upper section 15b are aligned with a corresponding set of apertures in the extended lower section 15c, a locking pin 31 can be threaded through the aligned apertures to firmly secure the two sections together as illustrated in FIG. 4. If the geometric configuration of the sections of the support legs are round or circular, one portion of each section can be provided with a flattened surface or insert 32 (FIG. 4) to facilitate alignment of the apertures thereby eliminate rotation of the lower section 15c to align its apertures with mating apertures in the upper section 15b. If the geometric configuration of the sections are oval, square or rectangular, a flattened surface or insert would not be necessary.

By way of illustration, a typical operation of the lifting device of the invention to lift, remove and temporarily re-position a manhole cover would proceed as follows. The device would first be unloaded from a carrier such as a maintenance truck and set horizontally on the ground. The lower section 15c of each of the support legs 15 would then be extended to a predetermined length and secured together with one or more locking pins 31 (FIGS. 1 and 4). The lifting device would then be raised to an upright position resting on its wheels 19 (FIG. 1) whereupon the support legs 15 would be pivoted outwardly until their upper ends 15a are firmly and securely engaged against the wall 14a of the U-shaped flanges 14. Next, the object engaging means which, in this instance, is the second wire cable flexible means having four lengths 28a-28d secured to the ring 29 at one end and having hook members 30 attached to their other ends would be attached to the snap lock mechanism 27 at the free end 26b of the first wire cable flexible means 26 (FIG. 1). The lifting device would then be rolled into position as shown in FIG. 1 over the manhole cover 33 to be lifted and moved. The brakes on wheels 19 would then be engaged to prevent the lifting device from rolling and to maintain the lifting device stabilized and secure in its position. The winch handle 25a on the boat winch 25 would then be rotated to lower the engaging means 28a-28d an amount sufficient to permit the four hooks 30 to be placed into the four holes typically provided in commercial manhole covers. Once the hooks 30 are in place, the winch handle 25a would then be rotated in the opposite direction with the winch locking mechanism engaging the teeth of the locking ratchet until the hooks 30 become firmly engaged by and secured to the manhole cover 33. Rotation of the winch handle 25a in the same direction would then be resumed until the manhole cover 33 is lifted free of the access port. At this time, the wheel brakes would be disengaged permitting the manhole cover 33 carried by the lifting device to be rolled out of the way to a remote location whereupon the wheel brakes would again be engaged to prevent the lifting device from moving.

After the required work has been accomplished, the manhole cover can be returned to cover and close the access port by generally reversing the procedure outlined above.

The materials used to construct the lifting device of the invention are not critical and such materials as various types of woods, metals, plastics or combinations thereof can be utilized provided they have the strength and durability to perform their designated functions.

Although the lifting device of the invention has been described in some detail and with particularity, it will be appreciated by those skilled in the art that changes and modifications can be made therein without departing from the scope and spirit of the invention.

What is claimed:

1. A lifting device comprising:
(a) a central housing member having a closed upper end and an open bottom;
(b) a plurality of support legs pivotally secured adjacent their upper ends to said housing member;
(c) a vertically disposed support member the upper end of which is secured to the closed upper end of said housing member and the lower end of which extends beyond the end of the open bottom of said housing member;
(d) a pulley secured to the lower end of said support member;
(e) a winch means mounted on one of said support legs intermediate its ends;
(f) a first flexible means one end of which is wound about said winch means, the other end of which is secured to a lock means and the intermediate length of which is threaded over said pulley; and,
(g) a second flexible means one end of which is removably attached to said lock means and the other end of which has means to engage and lift heavy objects.

2. The lifting device of claim 1 wherein said central housing member is a tubular cylinder and has a plurality of vertically disposed, U-shaped flange members secured about its outer circumferential surface

3. The lifting device of claim 2 wherein said support legs are pivotally secured within said U-shaped flanges.

4. The lifting device of claim 3 wherein the lower ends of said support legs are mounted on wheels equipped with a brake mechanism.

5. The lifting device of claim 1 wherein said support legs are provided in two sections, an upper section and a lower section telescopically seated in said upper section and a lock means to secure said upper section to said lower section when said lower section is telescopically extended.

6. The lifting device of claim 1 wherein said support member is an eye bolt secured to said upper end so that the eye of said eye bolt extends beyond said open bottom

7. The lifting device of claim 1 wherein said first flexible means is a wire cable encased in plastic.

8. The lifting device of claim 1 wherein said second flexible means comprises a plurality of wire cable lengths encased in plastic.

9. The lifting device of claim 8 wherein said wire cable lengths are from about 2′ to about 4′.

10. The lifting device of claim 8 wherein said wire cable lengths are from about 18″ to about 2′

11. The lifting device of claim 8 wherein said wire cable lengths are a mixture of lengths ranging from about 18″ to about 4′.

12. The lifting device of claim 1 wherein said engaging means are hook members.

13. A lifting device comprising:
(a) a tubular, cylindrical central housing member having a closed upper end and an open bottom;
(b) a plurality of vertically disposed, U-shaped flange members secured about the outer circumferential surface of said housing member;
(c) a plurality of support legs pivotally secured adjacent their upper ends within said U-shaped flange members and the lower ends thereof being mounted on wheel members equipped with brake means;
(d) a vertically disposed eye bolt within said housing member, the upper end of which is secured to said closed upper top and eye of which extends beyond said open bottom;
(e) a pulley secured to the eye of said eye bolt;
(f) a winch means secured to one of said support legs intermediate its ends;
(g) a first length of flexible wire cable encased in plastic, one end of which is wound about said winch means, the other end of which is secured to a lock means and the intermediate length of which is threaded over said pulley; and,
(h) a plurality of second flexible wire cable lengths encased in plastic, one end of each of said lengths are removably secured to said lock means and the other end of each of which has means to engage and lift heavy objects.

14. The lifting device of claim 13 wherein said support legs have an upper section and a lower section telescoped within said upper section and a lock means to secure said upper section to said lower section when said lower section is telescopically extended.

15. The lifting device of claim 13 wherein said second wire cable lengths are from about 2′ to about 4′.

16. The lifting device of claim 13 wherein said second wire cable lengths are from about 18″ to about 2′.

17. The lifting device of claim 13 wherein said second wire cable lengths are a mixture of lengths ranging from about 18″ to about 4′.

18. The lifting device of claim 13 wherein said engaging means are hook members.
